(19) United States
(12) Patent Application Publication
(10) Pub. No.: US 2007/0230838 A1
(43) Pub. Date: Oct. 4, 2007

(54) Compliant rail linear guide

(76) Inventor: Steven Fulton, Corte Madera, CA (US)

Correspondence Address: LARRY D. JOHNSON;REGISTERED PATENT ATTORNEY, Suite 110, 165 N. Redwood Dr.,, San Rafael, CA, 94903, US

(21) Appl. No.: 11/729,050

(22) Filed: Mar. 28, 2007

Related U.S. Application Data
(60) Provisional application No. 60/786,946, filed on Mar. 28, 2006.

(51) Int. Cl. F16C 19/00

(52) U.S. Cl. 384/57

(57) ABSTRACT

An improved rail and track assembly for a linear guide apparatus includes a rail support member with a pair of opposing track slots, each slot adapted to accommodate a track section terminating in a V-shaped proximal edge to mate with the groove in the guide rollers of a carriage. One side of the rail support has its track section fixed into its slot, pinned to the rail support at the ends to lock it into place. The opposing side of the rail support holds its track section in a similar slot and additionally accommodates a compliant (soft) element behind the track section. The compliant element fits in a recess between the bottom of the track slot and the flat distal edge of the track section. This second track section may also be pinned to the rail support at the ends to retain it in the slot, but preferably uses oversized holes in the track to allow it to move in and out of the slot and relative to the rail support to maintain fit-up with the guide rollers of the carriage. Because this compliant rail is able to move relative to the rail support, the guide rollers in the carriage may be fixed and do not need to be adjustable.

### CROSS REFERENCE TO RELATED APPLICATIONS

The present application claims the benefit of the filing date of U.S. Provisional Patent Application Ser. No. 60/786,946, filed Mar. 28, 2006.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to linear guide apparatus, and more particularly to an improved rail and track assembly for a linear guide apparatus.

### BACKGROUND INFORMATION AND DISCUSSION OF RELATED ART

Traditional linear guide designs use a machined rail support to accept the two opposing track sections, which are bolted down to the top of the rail support. The support is typically made from aluminum, while the track sections are made of hardened steel with a V-shape on one side. Guide rollers with mating V-grooves are mounted to an aluminum plate to make a sliding carriage. The carriage rolls between the tracks along its length.

The tracks need to be perfectly parallel so that the rail will roll smoothly. This is difficult and usually requires several adjustments. If it is not done correctly, the carriage will be loose at some points and tight in others as it travels from one end of the rail to the other.

The carriage fit-up is done by adjusting the rollers of the carriage to the track position. Line to line contact or a slight preload is ideal for a rigid and smooth running system. The guide rollers can be adjusted in two ways. One design provides a roller fastening bolt placed thru a slot in the carriage plate. The roller is moved laterally to set its position by opposing set screws. When the roller is adjusted, a nut is tightened to the bolt locking the roller in position. An alternate design provides an eccentric fastener to adjust the roller laterally. A nut is also used to lock the roller in position. These adjustments can only be done once prior to the system being put into operation.

Numerous inventions have been proposed to address these issues. For example, U.S. Pat. No. 4,968,155 to Bode discloses a rolling-bearing-mounted linear guiding unit comprising a hardened and polished guide rail on which rolling element raceways are formed and a guide carriage longitudinally displaceably mounted on the guide rail and provided with a fixing surface turned away from the guide rail and an inner contour adapted in shape to the profile of the guide rail, rolling elements rolling in endless race canals between the rolling element raceways of the guide rail and surfaces situated opposite to these in the guide carriage and a damping element being provided next to the guide carriage and forming a damping gap with the guide rail, characterized in that the damping element is formed as a saddle engaging around the guide rail, which saddle in respect of the guide rail, has a fixing surface identical to that of the guide carriage, the inner contour of the saddle being adapted for the most part to the profile of the guide rail so that these delimit a damping gap of 0 to 40.mu.m.

U.S. Pat. No. 5,176,454 to Schlereth describes an elastic bearing block for a linear guide constructed with two mutually perpendicularly crossing bending webs formed by crossed double slits.

U.S. Pat. No. 5,267,478 to Stridsberg teaches a device for the rapid precision positioning of a heavy carriage employing a stationary positioning bar, for instance a part of a linear electric motor or a gear rack, and a cooperating moving part of the linear motor or a motor attached to the carriage. The carriage is rapidly and roughly displaced with a further drive which may be constituted by a further gear wheel that cooperates with a gear rack and is driven by a separate motor attached to the carriage. This further drive additionally delivers a certain force for the final positioning in such a way that the play between the gear wheel and the gear rack is eliminated by biasing. Instead of a second gear wheel together with its motor a toothed belt, also driven by a separate motor, a pneumatic cylinder or a linear motor may be used. These are mounted separately from the carriage and are principally fixed in space.

U.S. Pat. No. 5,474,384 to Ludwig, et al. discloses a supporting bearing for linearly guided traveling units, having a housing and having a roller which contains a rolling-contact bearing and is seated on an eccentric bolt which is mounted rotatably in the housing and can be fixed by clamping bolts. The housing is composed of two housing halves which are preferably of the same construction. The axial position of the roller is determined by inner wall regions of the housing halves, which are laid or pressed against the end sides of the inner raceway of the roller after radial adjustment of the roller, by clamping the housing halves together. This results in the axial position of the roller being fixed directly by way of its inner raceway.

U.S. Pat. No. 5,547,285 to Hutzel, et al. describes a linear guide carriage guided on a guide rail by rollers. The rollers engage guideways. For lubricating the guideways there are mounted on the end faces of the guide carriage plate-shaped housings. Constructed in these plate-shaped housings are guides for lubricating element fittings. The lubricating element fittings accommodate track lubricating elements of felt. The lubricating element fittings are pressed against the guideways by pre-tensioning springs. The track lubricating elements are captively accommodated in the lubricating element fittings. The lubricating element fittings are captively guided in the guides. The track lubricating elements are in a lubricant conductive connection with lubricant supply chambers within the plate-shaped housing.

U.S. Pat. No. 5,820,269 to Ariga teaches a roller-type linear guide apparatus. A parallel guide apparatus comprises two roller-type linear guide apparatuses disposed in spaced-apart, confronting, parallel relation. Each roller-type linear guide apparatus comprises a rail and a slider slidably assembled into the rail via a roller. The rail is made by deforming a plate material to form a channel-shaped cross section. The slider has at least three rollers which are disposed such that their entire width becomes slightly larger than the distance between opposite guide planes of the rail. The rollers supported on the slider are brought into contact with guide planes of the rail. The rollers may be made of a sintered metal impregnated with a lubricant. The rollers in one of the roller-type linear guide apparatus are slightly movable toward the rollers in the other roller-type linear guide apparatus.

U.S. Pat. No. 6,213,646 to Yabe, et al. discloses a linear guide apparatus wherein end caps are respectively joined to opposite ends of a slider main body. Each end cap has curved passage for bringing the load rolling-element rolling groove of the slider main body into communication with the rolling-element return passage to thereby construct a rolling-element circulating passage for circulating a plurality of rolling elements. At least a portion of the end caps in contact with at least one of the rolling elements and guide rail is made of an oil containing material.

United States Patent Application 20020141667 by Ishihara describes a linear motion guide unit in which components are assembled in a mutually fitting relation with one another into a composite construction. This allows reducing the number of components to cope with a modern tendency of miniaturization of the linear motion guide system. The slider is composed of a carriage, end caps mounted on the fore-and-aft ends of the carriage, and carriage frame. The carriage has on inside surface thereof raceway grooves, while on outside surfaces thereof recesses and return-passage grooves. The end caps have turnarounds therein. The carriage frame includes side panels opposing to the outside surfaces of the carriage and end panels opposing to fore-and-aft end surfaces of the end caps. The side panels are made on the inside surfaces thereof with projections. For assembling the components into an unitary composite construction, the carriage together with the end caps is accommodated and held in the carriage frame by press fit of the projections of the side panels of the carriage frame into the recesses of the carriage.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The present invention provides an improved rail and track assembly for a linear guide apparatus. The inventive apparatus includes a rail support member with a pair of opposing track slots, each slot adapted to accommodate a track section terminating in a V-shaped proximal edge to mate with the groove in the guide rollers of a carriage. One side of the rail support has its track section fixed into its slot, pinned to the rail support at the ends to lock it into place. The opposing side of the rail support holds its track section in a similar slot and additionally accommodates a compliant (soft) element behind the track section. The compliant element fits in a recess between the bottom of the track slot and the flat distal edge of the track section. This second track section may also be pinned to the rail support at the ends to retain it in the slot, but preferably uses oversized holes in the track to allow it to move in and out of the slot and relative to the rail support to maintain fit-up with the guide rollers of the carriage.

Because this compliant rail is able to move relative to the rail support, the guide rollers in the carriage may be fixed and do not need to be adjustable. This is a simpler and lower cost design than those with adjustable rollers. The rollers are positioned so that when the carriage is slid onto the rail assembly, the floating track moves and compresses the compliant element. This compression creates a slight preload between the carriage and the rail assembly. The compliant rail adjusts dynamically to accommodate inaccuracies of component tolerances as well as deviations in track parallelism. The carriage maintains it's preload without getting loose or binding.

The inventive design is simple, low cost to produce and addresses the needs of most applications that call for this type of product. This design can be incorporated into 3 or 4 roller carriage designs, and enables unlimited, long stroke carriage travel. The inventive design provides an easy way to set the fit-up of a linear guide carriage in the rail, and does not require any initial or ongoing adjustments.

It is therefore an object of the present invention to provide a new and improved linear guide apparatus.

It is another object of the present invention to provide a new and improved linear guide apparatus that is simple and inexpensive to manufacture.

A further object or feature of the present invention is a new and improved linear guide apparatus that does not require adjustable rollers.

An even further object of the present invention is to provide a novel linear guide apparatus that adjusts dynamically to accommodate inaccuracies of component tolerances as well as deviations in track parallelism.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an end view of a three roller embodiment of a compliant linear guide assembly of this invention.

### DETAILED DESCRIPTION OF THE INVENTION

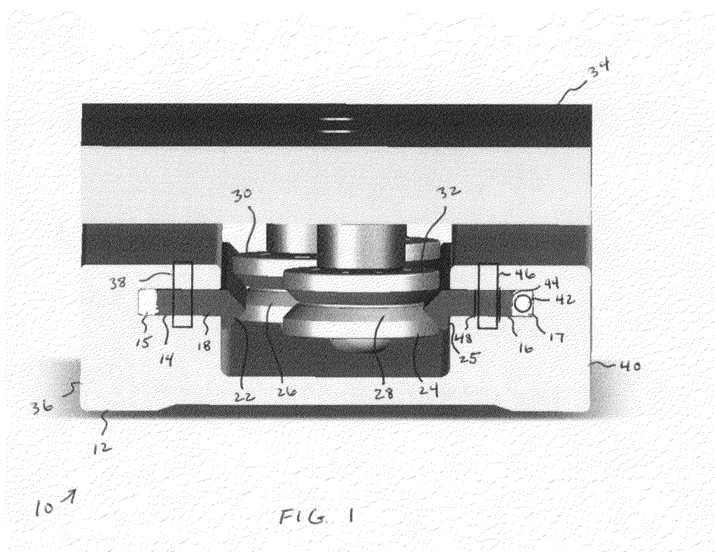

Referring to FIG. 1, there is illustrated therein a new and improved compliant rail linear guide apparatus, generally denominated 10 herein. FIG. 1 is an end view of a three roller embodiment of a compliant linear guide assembly of this invention. The inventive compliant rail assembly is equally applicable to a four roller embodiment.

The inventive apparatus 10 includes a rail support member 12 with a pair of opposing track slots 14, 16, each slot adapted to accommodate a track section 18, 20 terminating in a V-shaped proximal edge 22, 24 to mate with the groove 26, 28 in the guide rollers 30, 32 of a carriage 34. One side 36 of the rail support 12 has its track section 18 fixed into its slot 14, fastened by track mounting pin 38 to the rail support 12 at the ends to lock it into place. The opposing (compliant) side 40 of the rail support 12 holds its track section 20 in a slot 16 with a generally square recess 17 to accommodate a compliant (soft) element 42 behind the track section. This compliant element is preferably an elongate, round cross-section member made of rubber or neoprene material similar to that used to make O-rings, but may be made of any other suitable compliant material in any appropriate shape. The compliant element 42 fits in the recess 17 between the bottom of the track slot 16 and the generally flat distal edge 44 of the track section 20. This preferably round compliant element 42 set into the preferably generally square recess 17 enables the compliant element to compress and fill the corners of the recess. This second track section 20 may also be fastened by a track mounting pin 46 pinned to the rail support 12 at the ends to retain it in the slot, but preferably uses oversized holes 48 in the track to allow the track to move in and out of the slot 16 and relative to the rail support 12 to maintain fit-up with the guide roller 32 of the carriage 34.

In the preferred embodiment, there is also a recess 15 behind track section 18 in track slot 14. This gives the user the flexibility of putting the compliant element (O-ring) in either track slot depending on the load and mounting considerations. It also makes manufacture of the rail support (e.g., by aluminum extrusion) symmetrical and easier to produce. While it is possible to make a totally compliant system, i.e., with a compliant element in both track slots, most applications benefit from the load being carried by a fairly rigid track section. The compliant member makes sure that the rollers stay on the rigid side by using the spring force of the O-ring. This gives the system compliance for smooth travel, but also allows for more travel accuracy than if both tracks were allowed to move.

There should be a small gap 25 between the lip or shoulder of the track section and the outside surface of the extrusion. As the carriage rollers push the track section deeper into the track slot, the O-ring compresses, and the track needs to be able to move in and out of the track slot.

Accordingly, the invention may be characterized as a linear guide assembly for support of a movable carriage, the carriage including a plurality of guide rollers, the linear guide assembly comprising a rail support member with first and second track slots; a first track section fixed in the first track slot, the first track section having a V-shaped proximal edge adapted to mate with one of the guide rollers of the carriage; a second track section positioned in the second track slot, the second track section also having a V-shaped proximal edge adapted to mate with a different one of the guide rollers of the carriage, the second track section having a distal edge in the second track slot; and a compliant element situated in the second track slot adjacent the second track section distal edge, wherein the second track section is thereby enabled to move in and out of the second track slot and relative to the rail support member to maintain fit-up with a guide roller of the carriage.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A linear guide assembly for support of a movable carriage, the carriage including a plurality of guide rollers, said linear guide assembly comprising:
a rail support member with first and second track slots;
a first track section fixed in said first track slot, said first track section having a V-shaped proximal edge adapted to mate with one of the guide rollers of the carriage;
a second track section positioned in said second track slot, said second track section having a V-shaped proximal edge adapted to mate with a different one of the guide rollers of the carriage, said second track section having a distal edge in said second track slot; and
a compliant element situated in said second track slot adjacent said second track section distal edge, wherein said second track section is thereby enabled to move in and out of said second track slot and relative to said rail support member to maintain fit-up with a guide roller of the carriage.

2. The linear guide assembly of claim 1 wherein said second track section distal edge is generally flat.

3. The linear guide assembly of claim 1 wherein said compliant element comprises an elongate, round cross-section member.

4. The linear guide assembly of claim 1 wherein said compliant element comprises rubber.

5. The linear guide assembly of claim 1 wherein said compliant element comprises neoprene.

6. The linear guide assembly of claim 1 wherein said first track section is fixed in said first track slot by a track mounting pin.

7. The linear guide assembly of claim 1 wherein said second track section is secured in said second track slot by a track mounting pin in an oversized hole.

8. The linear guide assembly of claim 1 wherein said second track slot includes a recess to accommodate said compliant element.

9. The linear guide assembly of claim 8 wherein said recess is generally square.

10. The linear guide assembly of claim 1 wherein said first track slot includes a recess.
